(19) United States
(12) Patent Application Publication
(10) Pub. No.: US 2020/0383360 A1
(43) Pub. Date: Dec. 10, 2020

(54) METHOD FOR RECOVERING POMACE

(71) Applicant: Tropicana Products, Inc., Bradenton, FL (US)

(72) Inventors: Jin-E Shin, Hoffman Estates, IL (US); Raymond Spicochi, Lakewood Ranch, FL (US); Eduardo Patazca, Chicago, IL (US); Jeffrey Mathews, Naperville, IL (US)

(21) Appl. No.: 16/436,427

(22) Filed: Jun. 10, 2019

(51) Int. Cl. A23L 19/00

(52) U.S. Cl. CPC A23L 19/07; A23N 4/24

(57) ABSTRACT

A method of recovering pomace produced during the processing of whole fruits and vegetables is described. The method includes optionally enzymatically treating a cold mash during a blanching step to form a hot mash which is finished and then pasteurized and cooled to a temperature no greater than about 2° C. Thereafter, the pasteurized and cooled product is separated into juice and pomace, which has a temperature no greater than about 13° C. and which can be packaged for use.

The following disclosure relates to an improved method for recovering pomace generated during the processing of whole fruits and vegetables. More particularly, the invention relates to improved methods for producing a stable pomace product.

### BACKGROUND

Whole vegetables and fruits are generally not used in beverages because they contain ingredients such as skins, seeds, stems, roots, and the like which may affect the taste and mouthfeel of the beverage. Instead, juices and/or pulp are obtained from the vegetables and fruits with the skins, seeds, stems, roots, and the like discarded. These discarded ingredients are often in the form of pomace.

Pomace typically refers to the pulpy edible by-product remaining after fruit or vegetable juice pressing processes, wine crush operations, puree and concentrate operations, canning processes, and other food manufacturing processes. Pomace may include, for example, skins, pulp, and other edible parts of the fruit and vegetable such as apples, oranges, or carrots. In a juice extraction process, the pomace may be in the form of a part of press cake or the bottoms of a decanter/centrifuge.

For example, FIG. 1 depicts an exemplary fruit juice processing flow sheet for apple juice. In this process, apples are chopped, mashed and heated, optionally enzymatically treated, and then sent to a first stage extractor in the form of a decanter centrifuge in which the juice is separated from the pomace. In the depicted process, the pomace from the first stage extraction is further processed by being mixed with water, further enzymatically treated to recover more juice and then sent to a second stage extractor in the form of a decanter centrifuge in which the juice is separated from the pomace. The juice is then pasteurized and packaged while the pomace is dried, packaged, or disposed. In this known process, the pomace is removed prior to pasteurization of the juice.

One problem with this process is that the pomace produced in this manner is that the pomace is viscous and hard to process and is subject to microbial contamination. Accordingly, the pomace is typically dried and discarded as waste or used as animal feed, fertilizer, and substrate for microorganism growth.

It would be beneficial to recover pomace in a manner that is easily processed and is free from microbial contamination and can be used as a food ingredient. The following disclosure describes a method for providing a high moisture content edible pomace.

### SUMMARY

According to one aspect of the disclosure, a method is provided to recover pomace produced during the processing of whole fruits and vegetables. The method includes optionally enzymatically treating a cold mash during a blanching step to form a hot mash which is finished to provide a raw juice, which is then pasteurized and cooled to a temperature no greater than about 2° C. Thereafter, the pasteurized and cooled raw juice is separated into juice end product and pomace, which has a temperature no greater than about 13° C. and which can be packaged for use. The resulting pomace is enzymatically and microbially stable.

Advantageously, because the raw juice is pasteurized prior to separating the pomace, the pomace is easier to process as compared to known processes where the pomace is separated from raw juice prior to pasteurization. Further, according to the disclosed process, the resulting pomace is enzymatically and microbially stable.

The described method can be used to process any suitable fruit or vegetable such as, but not limited to, carrot, cranberry, orange, blueberry, tomato, apple, and any combination thereof. Lemons, limes, grapes, strawberries, grapefruits, tangerine, mandarin orange, tangelo, pomelo, celery, beet, lettuce, spinach, cabbage, artichoke, broccoli, Brussels sprouts, cauliflower, watercress, peas, beans, lentils, asparagus, onions, leeks, kohlrabi, radish, turnip, rutabaga, rhubarb, carrot, cucumber, zucchini, eggplant, pineapple, peach, banana, pear, guava, apricot, watermelon, Saskatoon berry, blueberry, plains berry, prairie berry, mulberry, elderberry, Barbados cherry (acerola cherry), choke cherry, date, coconut, olive, raspberry, strawberry, huckleberry, loganberry, currant, dewberry, boysenberry, kiwi, cherry, blackberry, quince, buckthorn, passion fruit, rowan, gooseberry, pomegranate, persimmon, mango, papaya, lychee, plum, prune, fig, or their combination.

Unless otherwise explicitly noted, all percentages in this disclosure refer to a percent by weight.

### BRIEF DESCRIPTION OF THE DRAWINGS

The following description accompanies the drawings, all given by way of non-limiting examples that may be useful to understand how the described process and system may be embodied.

FIG. 1 is a schematic drawing showing a prior art process for juice processing in which the pomace is obtained after a second-stage extraction.

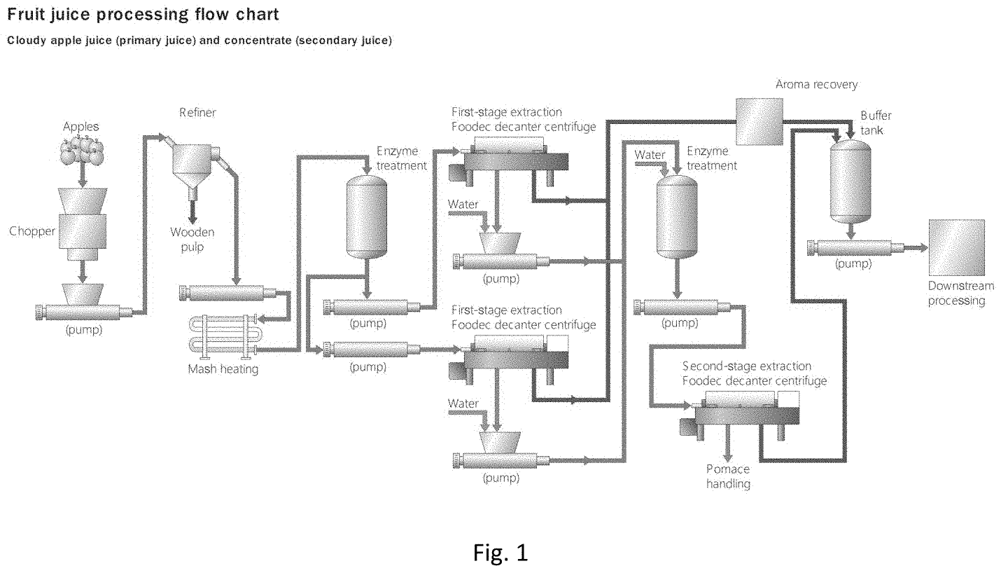

FIG. 2 is a schematic drawing showing one embodiment for juice processing to obtain an enzymatic and microbial stabilized pomace material.

### DESCRIPTION

Pomace refers to a natural by-product resulting from the extraction of juices from fruits and vegetables and other processes. Pomace contains natural nutrients (such as vitamin A, vitamin C, vitamin E, anthocyanins, and antioxidants), flavors, and/or colors of the original fruits and vegetables. Pomace also contains high natural (un-processed) fibers.

Wet pomace generally has a moisture content in the range between about 70 wt. % to about 85 wt. %. Most pomace contains over 50% (dry basis) of dietary fiber, mostly insoluble fiber, typically less than 10% by weight in wet pomace and varying amounts of essential vitamins, minerals and phytonutrients (depending on the type of fruit or vegetable and the process applied).

In this specification, the term “pomace” means the solid remains of a pomaceous fruit or vegetable after pressing of the fruit or vegetable to extract the fruit or vegetable juice/fruit or vegetable puree from the or vegetable. The pomace contains the pulp of the fruit or vegetable, but not the seeds, stems and other non-edible parts of the fruit or vegetable which have been removed from the solid remains of the fruit or vegetable in an upstream separation process. The pomace is in the form of a solid pulp containing residual moisture from the fruit or vegetable.

Pomace may be obtained from any suitable fruit or vegetable such as, but not limited to, carrot, cranberry, orange, blueberry, tomato, apple, and any combination thereof Lemons, limes, grapes, strawberries, grapefruits, tangerine, mandarin orange, tangelo, pomelo, celery, beet, lettuce, spinach, cabbage, artichoke, broccoli, Brussels sprouts, cauliflower, watercress, peas, beans, lentils, asparagus, onions, leeks, kohlrabi, radish, turnip, rutabaga, rhubarb, carrot, cucumber, zucchini, eggplant, pineapple, peach, banana, pear, guava, apricot, watermelon, Saskatoon berry, blueberry, plains berry, prairie berry, mulberry, elderberry, Barbados cherry (acerola cherry), choke cherry, date, coconut, olive, raspberry, strawberry, huckleberry, loganberry, currant, dewberry, boysenberry, kiwi, cherry, blackberry, quince, buckthorn, passion fruit, rowan, gooseberry, pomegranate, persimmon, mango, papaya, lychee, plum, prune, fig, or their combination. In particular, pomace obtained from orange, cranberry, and carrot provides valuable nutrients and fiber.

Pomace may also include the “goo” or the retentate formed from a filtration or decanting/centrifuging step of an extraction process, e.g., when clarifying a juice or vegetable. This filtration or decanting/centrifuging retentate may be obtained as a by-product, for example, from any suitable fruit or vegetable juice such as apple or carrot juices. Pomace (including this retentate) “as is” provides fiber, color, nutrients, mouthfeel, flavor.

The pomace contains natural nutrients (such as Vitamin A, vitamin C, vitamin E, phytonutrients such as polyphenols and antioxidants), flavors, colors of the original fruits and vegetables and large amount of a natural (e.g., un-processed fibers. Most extraction by-product contains over 40% by weight (dry basis) of dietary fiber. The use of pomace in food products can fortify fiber and naturally existing nutrients such as vitamins and phytochemicals. The use of pomace can also enable the addition of fruit and vegetable fiber to foods which will fortify the food products with fiber and with naturally existing nutrients such as vitamins and phytochemicals. Hence the use of pomace provides an excellent natural and label-friendly way to enhance quality of food products including, for example, beverages, soups, spreads, puddings, smoothies and snacks.

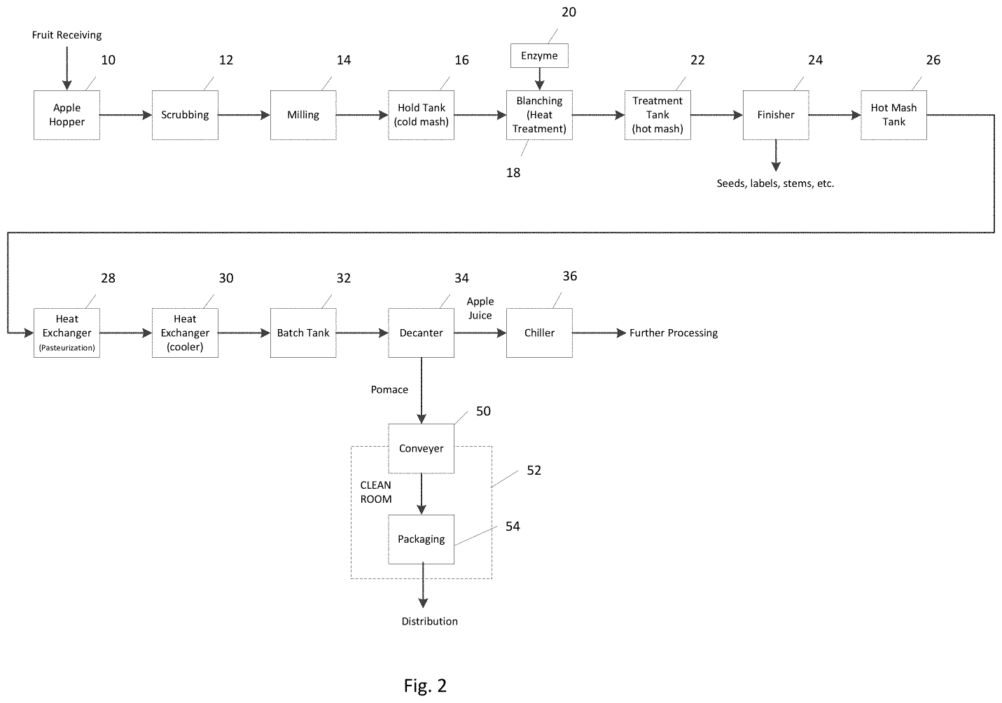

Turning now to FIG. 2, one embodiment of the method for producing an enzymatically and microbially stable pomace is shown. This embodiment will be described in connection with apples but of course, one of skill will appreciate that the process could be used with other fruits or vegetables.

The apples are received and collected in a hopper 10, where they are directed to a scrubber 12 for general cleaning and then passed through a grinding or hammer mill 14 to crush and reduce the size of the apples. In one embodiment, the apples are milled or ground to a size to pass through a sieve having openings from about 9 mm to about 10 mm. The milled apples (referred to as cold mash) are directed to a blanching step but may be stored in a hold tank 16 until there is a sufficient amount of cold mash for further processing by, for example, blanching.

The cold mash is then blanched by passing it through a heat exchanger 18 to heat the cold mash to a temperature between about 180° F. to about 210° F., or about 190° F. to about 200° F., or about 195° F. (about 90° C.) for a period of time less than about 60 seconds, or from about 5 to about 60 seconds, or from about 10 to about 30 seconds, or about 20 seconds to form a hot mash. Optionally, while the cold mash is being blanched, one or more enzymes 20 may be added to reduce the viscosity and the stickiness of the pomace without affecting protopectin. Suitable enzymes include but are not limited to pectinases, cellulases, hemicellulases, and the like.

The hot mash may sent directly to a finisher 24 or it may be stored in a holding tank 22 and thereafter passed to the finisher 24 to remove any solids (seeds, stems, labels, and other foreign materials) having a size greater than about 1 mm to about 2 mm, or about 1.5 mm to produce a raw juice. The raw juice contains juice end product and the pomace. The raw juice can be sent directly to a pasteurizer 28 or stored in a hot mash tank 26 before being processed in the pasteurizer 28.

The raw juice is pasteurized by heating in a pasteurizer 28 which may be a single unit that may include one or more heating zones, holding zones, and cooling zones. Alternatively, the pasteurizer may be in the form of separate units that may include a first heat exchanger 28 to heat the material and a second heat exchanger 30 located downstream of the first heat exchange 28 to cool the material.

Notwithstanding the configuration of the pasteurizer, the raw juice (juice end product and pomace) is heated to a temperature of at least 90° C., for a period ranging from about 4 seconds to about 200 seconds, which will deactivate any remaining optionally added enzyme, and then cooled to a temperature of less than about 5° C., or about 4° C., and typically to a temperature of about 1° C. to about 2° C. One of skill will understand that the time required to complete the pasteurization will depend on, among other things, the specific dimensions of the holding tubes, the flow through the holding tubes and thus the residence time necessary to achieve a bulk or average temperature of about 190° F. (about 90° C.) and to achieve a 5-log reduction of Cryptosporidium parvum.

The cooled pasteurized raw juice may be processed in a decanter/centrifuge 34 or stored in a batch tank 32 for future processing in the decanter/centrifuge 34. The cooled pasteurized raw juice or the batch tank 32 contents (pasteurized raw juice) is directed to the decanter 34 at a temperature not greater than about 4° C. to about 5° C.

The decanter/centrifuge 34 operates to separate the raw juice contents into a filtrate and a retentate or bottoms. The filtrate is the juice end product, such as apple juice, and contains less than about 5% solids, typically less than about 1% solids. The retentate or bottoms is the pomace to be collected. While operation of the decanter/centrifuge will impart energy to the contents which will effect an increase in the temperature of the pomace, it is desired to minimize any temperature increase to minimize contamination and/or microinfiltration into the pomace. Accordingly, the obtained pomace will have a maximum temperature of about 13° C., or about 10° C., or in a range of about 4° C. to about 13° C., or from about 4° C. to about 10° C.

The apple juice is then chilled 38 and sent to storage or further processing such as packaging.

The pomace from the decanter/centrifuge 34 is conveyed to a substantially sterile environment such as a clean room 52 where the pomace is packaged in, for example, drums for shipping. The pomace may be conveyed using a conveyer 50 such as auger or similar conveying apparatus.

Advantageously, the pomace contains about 70% to about 85% by weight moisture, or about 80% by weight moisture. The pomace is in the form of a solid pulp containing residual moisture from the fruit. The pomace typically has a total solids content of from about 5% to about 40% by weight, or from about 10% to about 30%; for example, a total solids content of from about 15% to about 25% by weight. The pomace may also have a total dietary fiber content of from about 1% to about 20% by weight, or from about 2% to about 15%; for example, from about 5% to about 12% by weight.

The produced pomace is free of enzymatic activity (i.e., the amount of any optionally added enzyme is below quantification) and microbial infiltration is inhibited by maintaining the pomace at a temperature less than about 13° C. and by packaging in a clean room. Accordingly, an enzymatically and microbially stable pomace is produced and can be readily and easily transported for further use.

Advantageously, the described process simplifies the processing of pomace, which is thick and viscous making it difficult to process and particularly to process to ensure that the produced pomace is free of microcontamination, and is enzymatically and microbially stable.

While the concepts of the present disclosure are susceptible to various modifications and alternative forms, specific exemplary embodiments of the disclosure have been shown by way of example in the drawings. It should be understood, however, that there is no intent to limit the concepts of the present disclosure to the particular disclosed forms; the intention is to cover all modifications, equivalents, and alternatives falling within the spirit and scope of the invention as defined by the claims.

1. A method for producing a stable pomace product comprising:
milling a fruit product to create a cold mash;
optionally enzymatically treating the cold mash while blanching to form a hot mash;
pasteurizing the hot mash;
cooling the pasteurized hot mash to a temperature no greater than 5° C.;
thereafter, separating pomace from juice;
wherein the pomace has a temperature no greater than about 13° C., a moisture content from about 75% to about 85%,

2. The method of claim 1, wherein the pasteurizing includes heating the hot mash to a temperature of at least 90° C. for a period of time ranging from about 3 to about 200 seconds

3. The method of claim 1 further comprising conveying the pomace to a sterile environment for packaging.
